(19) United States
(12) Patent Application Publication
(10) Pub. No.: US 2026/0140802 A1
(43) Pub. Date: May 21, 2026

(54) MULTI-CHIPLET SAFETY ISLAND-BASED SAFETY ERROR MANAGEMENT

(71) Applicant: QUALCOMM Incorporated, San Diego, CA (US)

(72) Inventors: Prashant SINGH, Kanpur (IN); Deepak BARANWAL, Greater Noida (IN); Sriram HARIHARAN, San Diego, CA (US)

(21) Appl. No.: 18/952,838

(22) Filed: Nov. 19, 2024

(51) Int. Cl. G06F 11/20

(52) U.S. Cl. CPC G06F 11/0739; G06F 11/0766; G06F 11/0793; G06F 2201/805

(57) ABSTRACT

A processor-implemented method for multi-chiplet safety island-based safety error management includes monitoring, by a first safety integrated circuit (IC) of a system-on-a-chip (SoC), a first chiplet of multiple chiplets of the SoC for one or more fault conditions. The first safety IC aggregates a first set of the one or more fault conditions for the first chiplet of the multiple chiplets of the SoC. The first safety IC communicates information of the first set of the one or more fault conditions for the first chiplet of the multiple chiplets of the SoC to a second safety IC of the SoC.

### BACKGROUND

### Field

Aspects of the present disclosure relate to computing devices, and more specifically to multi-chiplet safety island-based safety error management.

### Background

Mobile or portable computing devices include mobile phones, laptop, palmtop and tablet computers, portable digital assistants (PDAs), portable game consoles, and other portable electronic devices. Mobile computing devices are comprised of many electrical components that consume power and generate heat. The components (or compute devices) may include system-on-a-chip (SoC) devices, graphics processing unit (GPU) devices, neural processing unit (NPU) devices, digital signal processors (DSPs), and modems, among others.

The incorporation of compute devices in automotive systems is rapidly increasing. Modern automobiles may utilize several computing systems to enable a wide array of functionalities. For instance, computing systems may enhance vehicle performance including engine control brake assist, user experience including infotainment, as well as safety applications including lane departure and proximity awareness. Still further applications may be realized in battery or power management, vehicle-to-everything communication and autonomous vehicle navigation and piloting.

Safety monitoring and error recovering is a mandatory feature for automotive system on systems-on-a-chip (SoC) complying with automotive safety integrity level (ASIL) certification requirements. A central safety manager monitors and generates safety errors and communicates to an external microcontroller unit (MCU). As such, for conventional multi-chiplet architectures, when any one chiplet has a fatal fault, the entire automotive SoC is restarted, including chiplets that did not experience a fatal fault.

### SUMMARY

Various aspects of the present disclosure are directed to an apparatus. The apparatus includes means for monitoring, by a first safety integrated circuit (IC) of a system-on-a-chip (SoC), a first chiplet of multiple chiplets of the SoC for one or more fault conditions. The apparatus also includes means for aggregating, by the first safety IC, a first set of the one or more fault conditions for the first chiplet of the multiple chiplets of the SoC. The apparatus further includes means for communicating, by the first safety IC, information of the first set of the one or more fault conditions for the first chiplet of the multiple chiplets of the SoC to a second safety IC of the SoC.

In some aspects of the present disclosure, a processor-implemented method performed by one or more processors includes monitoring, by a first safety integrated circuit (IC) of a system-on-a-chip (SoC), a first chiplet of multiple chiplets of the SoC for one or more fault conditions. The processor-implemented method also further includes aggregating, by the first safety IC, a first set of the one or more fault conditions for the first chiplet of the multiple chiplets of the SoC. The processor-implemented method further includes communicating, by the first safety IC, information of the first set of the one or more fault conditions for the first chiplet of the multiple chiplets of the SoC to a second safety IC of the SoC.

Various aspects of the present disclosure are directed to an automotive system-on-a-chip (SoC). The automatic SoC has a first chiplet coupled to a first safety integrated circuit (IC). The first safety IC monitors the first chiplet for one or more fault conditions. The automatic SoC also includes a second chiplet coupled to a second safety IC. The second safety IC monitors the first chiplet for the one or more fault conditions. The first safety IC aggregates a first set of the one or more fault conditions for the first chiplet and communicates information of the first set of the one or more fault conditions to the second safety IC.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a host system-on-a-chip (SoC), which includes a safety island for each chiplets of a multi-chiplet architecture, in accordance with aspects of the present disclosure.

FIG. 2 is a block diagram illustrating an example multi-chiplet architecture of an SoC including a safety island for each chiplet, in accordance with various aspects of the present disclosure.

FIG. 3 is a flow diagram illustrating an example process for managing faults in a multi-chiplet SoC, in accordance with various aspects of the present disclosure.

FIG. 4 is a flow diagram illustrating an example process for managing faults in a multi-chiplet SoC, in accordance with various aspects of the present disclosure.

FIG. 5 is a flow diagram illustrating an example process performed, for example, by an integrated circuit device, in accordance with various aspects of the present disclosure.

FIG. 6 is a block diagram showing an exemplary wireless communications system in which a configuration of the present disclosure may be advantageously employed.

FIG. 7 is a block diagram illustrating a design workstation used for circuit, layout, and logic design of components, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts.

As described, the use of the term “and/or” is intended to represent an “inclusive OR,” and the use of the term “or” is intended to represent an “exclusive OR.” As described, the term “exemplary” used throughout this description means “serving as an example, instance, or illustration,” and should not necessarily be construed as preferred or advantageous over other exemplary configurations. As described, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described, the term “proximate” used throughout this description means “adjacent, very near, next to, or close to.” As described, the term “on” used throughout this description means “directly on” in some configurations, and “indirectly on” in other configurations.

Automotive systems-on-a-chip (SoCs) may be employed to realize various advanced automotive comfort and safety features. The complexity of automotive SoCs continues to increase to meet the demand for more advanced automotive functionality and interoperability. With growing die area and complexity, automotive SoCs may be designed as two-chiplet based solutions. A chiplet may refer to a smaller, modular integrated circuit (IC) component in IC chip design. Rather than integrate multiple functionalities into a single monolithic chip, the functionalities may be provided by incorporating into multiple separate chiplets.

Each of the chiplets may, for instance, be an intellectual property (IP) core. IP cores may be considered reusable logic units, cells, or chip layout designs used in the development of ICs. IP cores are essential building blocks for creating complex SoCs. Many semiconductor designs, both in IC and in field programmable gate array (FPGA) applications, are constructed in a modular fashion by combining a set of IP cores, such as central processing units (CPUs), digital signal processors (DSPs), video and networking processing blocks, memory controllers, and others with an interconnect system. IP cores are used in various applications, including processors, memory controllers, communication interfaces, and custom accelerators.

The interconnect system implements the system-level communications of the particular design. The IP cores may be designed using a standard IP interface protocol, either public or proprietary. These IP interface protocols are referred to as transaction protocols. An example transaction protocol is Open Core Protocol (OCP) from OCP-IP, and Advanced Extensible Interface (AXI™) and Advanced High-performance Bus (AHB™).

In conventional applications, each chiplet may have a safety IP which may generate safety errors in response to a safety fault (e.g., permanent or transient). These safety faults may have to be monitored and communicated to an external microcontroller unit (MCU) in an automotive system. Safety faults may comprise (but are not limited to) memory cache coherency faults, parity faults, protocol related faults that affect safety data transmission, temperature faults, clock drift faults, voltage glitches, and other faults. Additionally, such faults can be fatal (e.g., may cause the full chiplet to crash or restart) or may be recoverable (e.g., using a partial restart of any IP/subsystem).

Accordingly, to address these and other issues, aspects of the present disclosure are directed to an automotive SoC that incorporates safety island hardware with each chiplet of a multi-chiplet architecture. A safety island is a dedicated, isolated, integrated circuit device that may be embedded within an SoC. Each safety island may operate in an island mode with an independent clock and/or independent electrical supply thus providing a capability to operate independently of other operating conditions of the SoC. Each safety island may also monitor faults with a corresponding chiplet of the multi-chiplet architecture and may communicate safety-related information such as faults to an MCU. In some aspects, the MCU features may be incorporated within a chiplet SoC. Additionally in some aspects, each safety island may be configurable to support multiple-die safety wherein the chiplets may be identical as well as non-identical chiplets.

Particular aspects of the subject matter described in this disclosure can be implemented to realize one or more of the following potential advantages. In some examples, the described techniques (e.g., the incorporation of safety islands (may also be referred to as safety ICs) with each chiplet of the automotive SoC) may enable increased safety redundancy and processor availability.

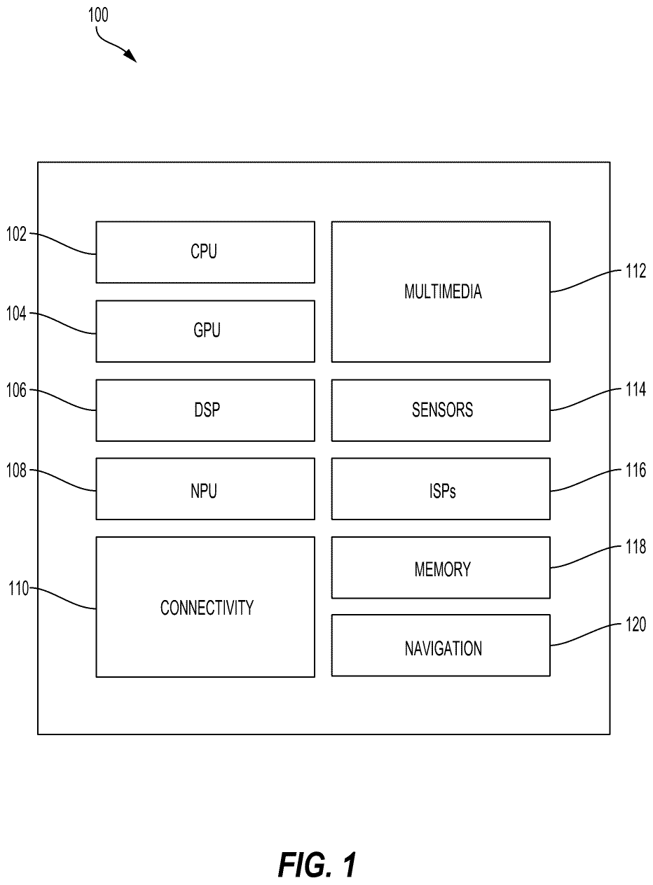

FIG. 1 illustrates an example implementation of a host system-on-a-chip (SoC) 100, which includes a safety island for each chiplet in a multi-chiplet architecture, in accordance with aspects of the present disclosure. The host SoC 100 includes processing blocks tailored to specific functions, such as a connectivity block 110. The connectivity block 110 may include fifth generation (5G) connectivity, fourth generation long term evolution (4G LTE) connectivity, Wi-Fi connectivity, universal serial bus (USB) connectivity, Bluetooth® connectivity, Secure Digital (SD) connectivity, and the like.

In this configuration, the host SoC 100 includes various processing units that support multi-threaded operation. For the configuration shown in FIG. 1, the host SoC 100 includes a multi-core central processing unit (CPU) 102, a graphics processor unit (GPU) 104, a digital signal processor (DSP) 106, and a neural processor unit (NPU) 108. The host SoC 100 may also include a sensor processor 114, image signal processors (ISPs) 116, a navigation module 120, which may include a global positioning system (GPS), and a memory 118. The multi-core CPU 102, the GPU 104, the DSP 106, the NPU 108, and the multi-media engine 112 support various functions such as video, audio, graphics, gaming, artificial networks, and the like. Each processor core of the multi-core CPU 102 may be a reduced instruction set computing (RISC) machine, an advanced RISC machine (ARM), a microprocessor, or some other type of processor. The NPU 108 may be based on an ARM instruction set.

Aspects of the present disclosure are directed to multi-chiplet safety island-based safety error management.

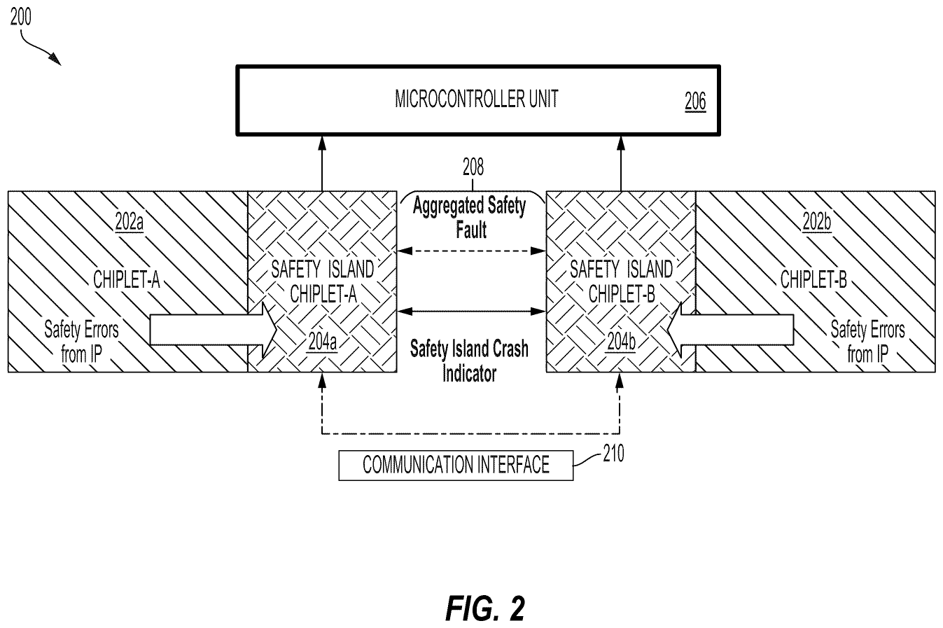

FIG. 2 is a block diagram illustrating an example multi-chiplet architecture 200 of an SoC including a safety island for each chiplet, in accordance with various aspects of the present disclosure. Referring to FIG. 2, the example multi-chiplet architecture 200 may include a first chiplet 202a and a second chiplet 202b. Two chiplets 202a, 202b are shown in the example multi-chiplet architecture 200 for ease of illustration and understanding. However, the present disclosure is not so limiting, and instead, the example multi-chiplet architecture 200 may include more than two chiplets.

Each chiplet 202a, 202b may include an IP core such as a CPU 102, DSP 106, and NPU 108, for instance. Each chiplet 202a, 202b may have a corresponding safety island 204a, 204b. For instance, safety island hardware may be added to each of chiplets 202a, 202b. Each safety island 204a, 204b may comprise an integrated circuit device that may be embedded within an SoC (e.g., SoC 100 of FIG. 1). The safety islands 204a, 204b may manage and monitor faults within the corresponding chiplet (e.g., 202a, 202b). Safety faults may comprise (but are not limited to) memory cache coherency faults, parity faults, protocol related faults that affect safety data transmission, temperature faults, clock drift faults, voltage glitches, and other faults.

The safety islands 204a, 204b may monitor and manage the faults of the corresponding chiplet (e.g., 202a, 202b) independently from other elements of the SoC. That is, the safety islands 204a, 204b may operate in isolation from other elements of the SoC so that the safety islands 204a, 204b may each maintain is functionality despite other conditions on the SoC. Each safety islands 204a, 204b may aggregate the faults within the corresponding chiplet (e.g., 202a, 202b). In some aspects, the faults (e.g., errors) may be configured for overall error aggregation as single channel (e.g., with errors aggregated from safety islands 204a and 204b) or as parallel channels without any error aggregation.

The safety islands 204a, 204b may communicate faults to an external MCU 206 for instance, to request a corrective action to address the aggregated faults.

The safety islands 204a, 204b for each chiplet 202a, 202b may be connected with a die-to-die connection 208. The safety islands 204a, 204b respectively for chiplets 202a, 202b may communicate an indication of faults for the respective chiplets to each other. As such, the die-to-die connection 208 may enable the safety islands 204a, 204b for both chiplets 202a, 202b to monitor a set of aggregated fault conditions of each chiplet 202a, 202b. The example multi-chiplet architecture 200 may also include a communication interface 210 between the safety islands 204a, 204b to communicate fault information in a chiplet (e.g., 202a, 202b). The communication interface 210 may comprise (but is not limited to) a universal asynchronous receiver/transmitter (UART) communication link or other standard communication link or other custom communication protocol to enable communication between the chiplets.

Any of the safety islands (e.g., 204a, 204b) may serve as a primary safety island. The primary safety island (e.g., 204a or 204b) may communicate faults to the external MCU 206. If, for instance, the safety island 204a for the chiplet 202a experiences a fatal error and crashes, the safety island 204b may serve as a primary safety island for communication to the MCU 206. The fatal error/crash of a safety island (e.g., 204a) may be communicated to another safety island (e.g., 204b) through the die-to-die connection 208.

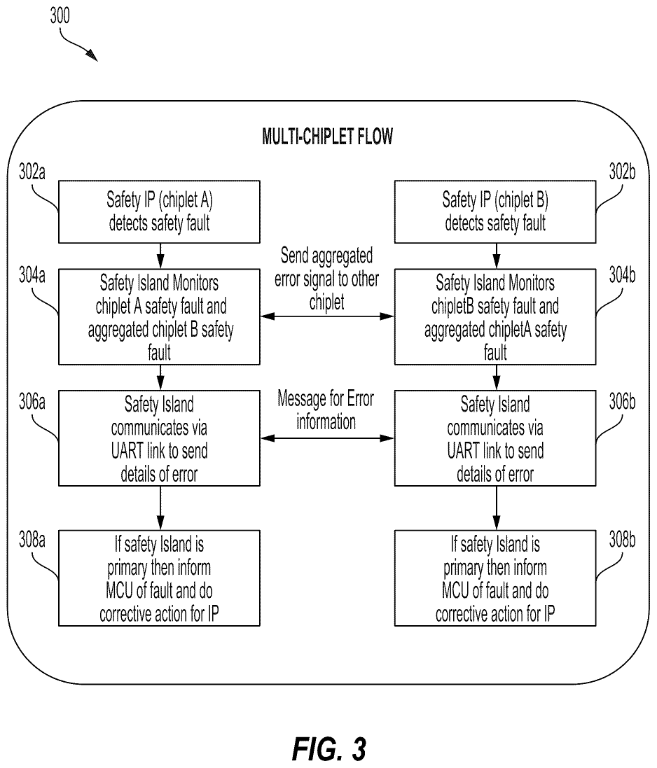

FIG. 3 is a flow diagram illustrating an example process 300 for managing faults in a multi-chiplet SoC, in accordance with various aspects of the present disclosure. Referring to FIG. 3, the example process 300 may, at block 302a, include detection of a safety fault by a first safety island (e.g., 204a,) at a safety IP (e.g., chiplet 202a) of an SoC (e.g., SoC 100 of FIG. 1). Similarly, at block 302b, a second safety island (e.g., 204b) may detect a safety fault at a second safety IP (e.g., chiplet 202b).

At block 304a, the first safety island (e.g., 204a) may monitor the first chiplet (e.g., 202a). The first safety island (e.g., 204a) may also receive, from the second safety island (e.g., 204b), information regarding the safety faults of other chiplets (e.g., 202b). For instance, the first safety island (e.g., 204a) may receive an indication of the aggregated fault conditions for the second chiplet (e.g., 202b) from the second safety island (e.g., 204b) using the die-to-die connection 208. As such, the first safety island (e.g., 204a) may monitor the set of aggregated fault conditions for the second chiplet (e.g., 202b). Thus, if the second safety island (e.g., 204b) becomes disabled (e.g., restarts), the first safety island may continue to monitor the second chiplet (e.g., 202b).

Similarly, at block 304b, the second safety island (e.g., 204b) may monitor the second chiplet (e.g., 202b). The second safety island (e.g., 204b) may also receive, from the first safety island (e.g., 204a), information regarding the safety faults of the other chiplets (e.g., 202a). For example, the second safety island (e.g., 204b) may receive an indication of the set of aggregated fault conditions for the first chiplet (202a) from the first safety island (204a) using a die-to-die connection (e.g., 208). Thus, the second safety island (e.g., 204b) may also monitor the set of aggregated fault conditions for the first chiplet (202a). Thus, if the first safety island (e.g., 204a) becomes disabled (e.g., restarts), the second safety island (e.g., 204b) may continue to monitor the first chiplet (e.g., 202a).

At block 306a, the first safety island (e.g., 204a) may communicate further details of the detected safety faults for the first chiplet (e.g., 202a) to the second safety island (e.g., 204b) using a UART communication link (e.g., 210) or other communication interface. Similarly, at block 306b, the second safety island (e.g., 204b) may also communicate further details of the detected safety faults for the second chiplet (e.g., 202b) to the first safety island (e.g., 204a) using the UART communication link (e.g., 210).

At block 308a, if the first safety island (e.g., 204a) is the primary safety island, then the first safety island (e.g., 204a) may communicate to an MCU (e.g., 206), the information regarding the safety faults for the chiplets (e.g., 202a, 202b). In some aspects, the first safety island (e.g., 204a) may initiate corrective action (e.g., a restart) for one or more of the chiplets (e.g., 202a, 202b) by the MCU (e.g., 206).

On the other hand, at block 308b, if the second safety island (e.g., 204a) is the primary safety island, then the second safety island (e.g., 204b) may communicate to the MCU (e.g., 206), the information regarding the safety faults for each of chiplets (e.g., 202a and 202b). In some aspects, the second safety island (e.g., 204b) may initiate corrective action (e.g., a restart) for one or more of the chiplets (e.g., 202a, 202b) by the MCU (e.g., 206).

Unlike conventional single die safety island fatal error processing, in which a single safety island sends the MCU an indication of the fatal error to restart the full single die SoC, the chiplet experiencing the safety faults may be restarted while the other chiplets may continue to operate.

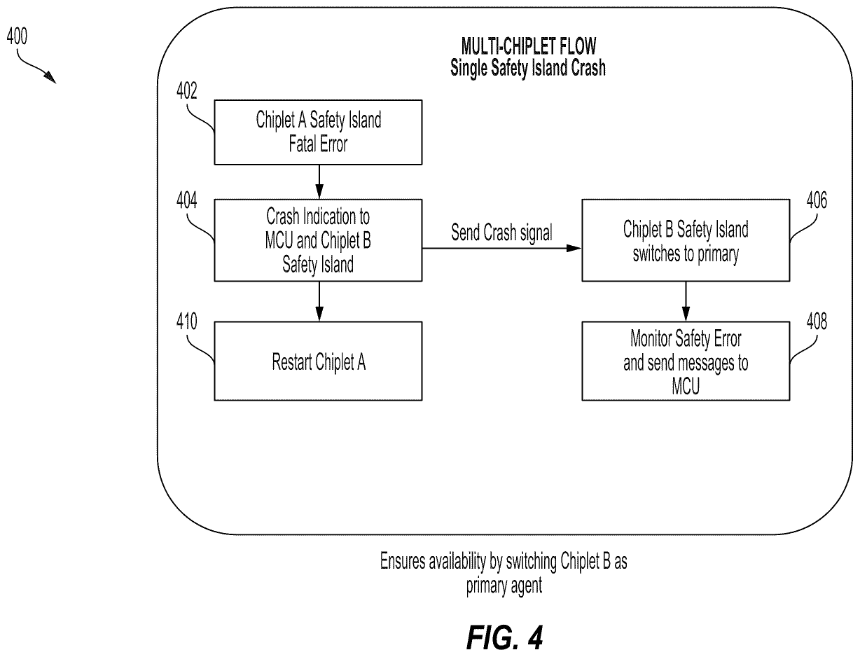

FIG. 4 is a flow diagram illustrating an example process 400 for managing faults in a multi-chiplet SoC, in accordance with various aspects of the present disclosure. Referring to FIG. 4, at block 402, a first safety island (e.g., 204a) for a first chiplet (e.g., 202a) may experience a fatal error. At block 404, a fatal error (e.g., crash) indication may be sent to an MCU (e.g., 206) and a second safety island (e.g., 204b).

In response to receiving the fatal error indication from the first safety island (e.g., 204a), at block 406, the second safety island (e.g., 204b) for a second chiplet (e.g., 202b) may become or may be designated the primary safety island. Thereafter, at block 408, the second safety island (e.g., 204b) may monitor safety faults and communicate with the MCU (e.g., 206).

At block 410, the MCU (e.g., 206) may send a control signal to restart the first chiplet (e.g., 202a). Notably, because the second safety island (e.g., 204b) manages the second chiplet (e.g., 202b), the first chiplet (e.g., 202a) may be restarted without restarting the second chiplet (e.g., 202b). In some aspect, MCU may send the control signal for restart concurrently with designating the second safety island (e.g., 204b) as the primary (block 406) and/or the second safety island (e.g., 204b) monitoring safety error messages and communicating with the MCU (block 408). Accordingly, various aspects of the present disclosure may provide additional redundancy in fault management for IP core chiplets. Because of the additional redundancy, increased availability in safety management may be achieved.

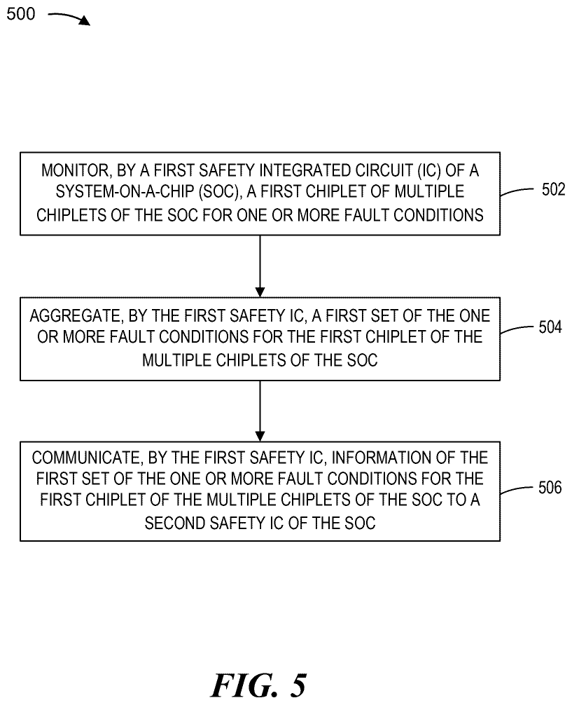

FIG. 5 is a flow diagram illustrating an example process 500 performed, for example, by an integrated circuit device, in accordance with various aspects of the present disclosure. The example process 500 is an example of managing faults in a multi-chiplet SoC.

As shown in FIG. 5, in some aspects, at block 502, the process 500 may include monitoring, by a first safety integrated circuit (IC) of a system-on-a-chip (SoC), a first chiplet of the SoC for one or more fault conditions. As described, for instance, with reference to FIG. 2, an SoC may include multiple chiplets. Each chiplet 202a, 202b may include an IP core such as a CPU 102, DSP 106, and NPU 108, for instance. Each chiplet 202a, 202b may have a corresponding safety island 204a, 204b. For instance, safety island hardware may be added to each of chiplets 202a, 202b. Each safety island 204a, 204b may comprise an integrated circuit device that may be embedded within an SoC (e.g., SoC 100 of FIG. 1). The safety islands 204a, 204b may manage and monitor faults within the corresponding chiplet (e.g., 202a, 202b) may independently from other elements of the SoC.

At block 504, the process 500 includes aggregating, by the first safety IC, a first set of the one or more fault conditions for the first chiplet of the SoC. For example, as described with reference to FIG. 2, each safety islands 204a, 204b may aggregate the faults within the corresponding chiplet (e.g., 202a, 202b).

At block 506, the process 500 includes communicating, by the first safety IC, information of the first set of the one or more fault conditions for the first chiplet of the SoC to a second safety IC of the SoC. For example, as described with reference to FIG. 2, the safety islands 204a, 204b for each chiplet 202a, 202b may be connected with a die-to-die connection 208. The safety islands 204a, 204b respectively for chiplets 202a, 202b may communicate an indication of faults for the respective chiplets to each other. As such, the die-to-die connection 208 may enable the safety islands 204a, 204b for both chiplets 202a, 202b to monitor a set of aggregated fault conditions of each chiplet 202a, 202b.

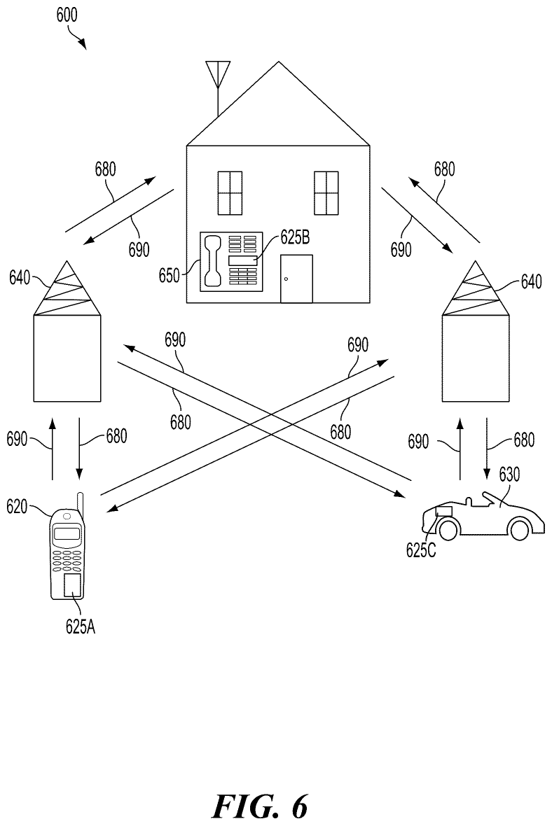

FIG. 6 is a block diagram showing an exemplary wireless communications system 600, in which an aspect of the present disclosure may be advantageously employed. For purposes of illustration, FIG. 6 shows three remote units 620, 630, and 650, and two base stations 640. It will be recognized that wireless communications systems may have many more remote units and base stations. Remote units 620, 630, and 650 include integrated circuit (IC) devices 625A, 625B, and 625C that include the disclosed multi-chiplet SoC with multiple safety islands. It will be recognized that other devices may also include the disclosed multi-chiplet SoC with multiple safety islands, such as the base stations, switching devices, and network equipment. FIG. 6 shows forward link signals 680 from the base stations 640 to the remote units 620, 630, and 650, and reverse link signals 690 from the remote units 620, 630, and 650 to the base stations 640.

In FIG. 6, remote unit 620 is shown as a mobile telephone, remote unit 630 is shown as an automobile, and remote unit 650 is shown as a fixed location remote unit in a wireless local loop system. For example, the remote units may be a mobile phone, a hand-held personal communication systems (PCS) unit, a portable data unit, such as a personal data assistant, a GPS enabled device, a navigation device, a set top box, a music player, a video player, an entertainment unit, a fixed location data unit, such as meter reading equipment, or other device that stores or retrieves data or computer instructions, or combinations thereof. Although FIG. 6 illustrates remote units according to the aspects of the present disclosure, the disclosure is not limited to these exemplary illustrated units. Aspects of the present disclosure may be suitably employed in many devices, which include the disclosed multi-chiplet SoC with multiple safety islands.

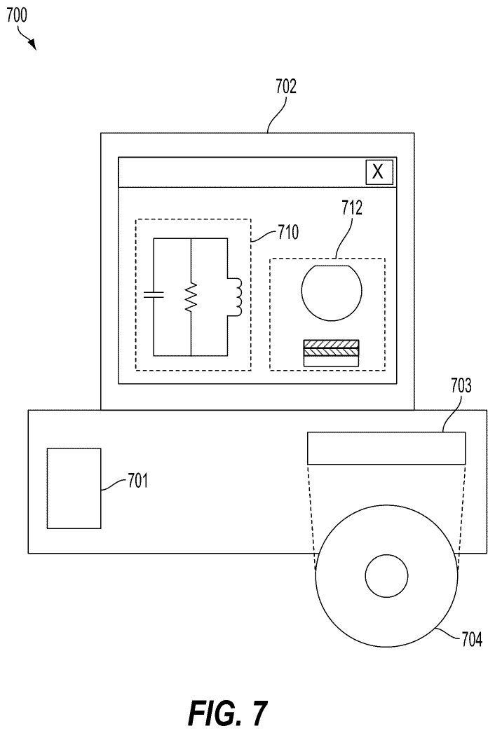

FIG. 7 is a block diagram illustrating a design workstation 700 used for circuit, layout, and logic design of a semiconductor component, such as the multi-chiplet SoC with multiple safety islands disclosed above. The design workstation 700 includes a hard disk 701 containing operating system software, support files, and design software such as Cadence or OrCAD. The design workstation 700 also includes a display 702 to facilitate design of a circuit 710 or a semiconductor component 712, such as the multi-chiplet SoC with multiple safety islands. A storage medium 704 is provided for tangibly storing the design of the circuit 710 or the semiconductor component 712 (e.g., the multi-chiplet SoC with multiple safety islands). The design of the circuit 710 or the semiconductor component 712 may be stored on the storage medium 704 in a file format such as GDSII or GERBER. The storage medium 704 may be a CD-ROM, DVD, hard disk, flash memory, or other appropriate device. Furthermore, the design workstation 700 includes a drive apparatus 703 for accepting input from or writing output to the storage medium 704.

Data recorded on the storage medium 704 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 704 facilitates the design of the circuit 710 or the semiconductor component 712 by decreasing the number of processes for designing semiconductor wafers.

### Example Aspects

Aspect 1: An automotive system-on-a-chip (SoC), comprising: a first chiplet coupled to a first safety integrated circuit (IC), the first safety IC monitoring the first chiplet for one or more fault conditions; and a second chiplet coupled to a second safety IC, the second safety IC monitoring the first chiplet for the one or more fault conditions, in which the first safety IC aggregates a first set of the one or more fault conditions for the first chiplet and communicates information of the first set of the one or more fault conditions to the second safety IC.

Aspect 2: The automotive SoC of Aspect 1, in which the second safety IC aggregates a second set of the one or more fault conditions for the second chiplet and communicates information of the second set of the one or more fault conditions to the first safety IC.

Aspect 3: The automotive SoC of Aspect 1 or 2, in which one of the first safety IC or the second safety IC is designated as a primary safety IC, and the primary safety IC communicates information for one or more of the first set of the one or more fault conditions or the second set of the one or more fault conditions to a controller.

Aspect 4: The automotive SoC of any preceding Aspect, in which the primary safety IC communicates with the controller to initiate a corrective action for the one or more of the first set of the one or more fault conditions or the second set of the one or more fault conditions.

Aspect 5: The automotive SoC of any preceding Aspect, further comprising a communication interface coupled between the first safety IC and the second safety IC, in which either of the first safety IC or the second safety IC are configured to communicate information of the first set of the one or more fault conditions or the second set of the one or more fault conditions to another safety IC via the communication interface.

Aspect 6: The automotive SoC of any preceding Aspect, in which either of the first safety IC or the second safety IC are configured to monitor multiple chiplets.

Aspect 7: The automotive SoC of any preceding Aspect, in which the first safety IC and the second safety IC are arranged in a daisy chain configuration to enable failsafe operation using one of the first safety IC or the second safety IC.

Aspect 8: A processor-implemented method performed by one or more processors, the processor-implemented method, comprising: monitoring, by a first safety integrated circuit (IC) of a system-on-a-chip (SoC), a first chiplet of multiple chiplets of the SoC for one or more fault conditions; aggregating, by the first safety IC, a first set of the one or more fault conditions for the first chiplet of the SoC; and communicating, by the first safety IC, information of the first set of the one or more fault conditions for the first chiplet of the SoC to a second safety IC of the SoC.

Aspect 9: The processor-implemented method of Aspect 8, further comprising: monitoring, by the second safety IC of the SoC, a second chiplet of the multiple chiplets of the SoC for the one or more fault conditions; aggregating, by the second safety IC, a second set of the one or more fault conditions for the second chiplet; and communicating, by the second safety IC, information of the second set of the one or more fault conditions to the first safety IC.

Aspect 10: The processor-implemented method of Aspect 8 or 9, in which one of the first safety IC or the second safety IC is designated as a primary safety IC, and the processor-implemented method further comprises communicating, by the primary safety IC, information for one or more of the first set of the one or more fault conditions or the second set of the one or more fault conditions to a controller.

Aspect 11: The processor-implemented method of any of Aspects 8-10, in which the primary safety IC communicates with the controller to initiate a corrective action for the one or more of the first set of the one or more fault conditions or the second set of the one or more fault conditions.

Aspect 12: The processor-implemented method of any of Aspects 8-11, in which the first safety IC or the second safety IC are configured to communicate information of the first set of the one or more fault conditions or the second set of the one or more fault conditions to another safety IC using a communication interface coupled between the first safety IC and the second safety IC.

Aspect 13: The processor-implemented method of any of Aspects 8-12, in which either of the first safety IC or the second safety IC are configured to monitor multiple chiplets.

Aspect 14: An apparatus, comprising: means for monitoring, by a first safety integrated circuit (IC) of a system-on-a-chip (SoC), a first chiplet of multiple chiplets of the SoC for one or more fault conditions; means for aggregating, by the first safety IC, a first set of the one or more fault conditions for the first chiplet of the multiple chiplets of the SoC; and means for communicating, by the first safety IC, information of the first set of the one or more fault conditions for the first chiplet of the multiple chiplets of the SoC to a second safety IC of the SoC.

Aspect 15: The apparatus of Aspect 14, further comprising: means for monitoring, by the second safety IC of the SoC, a second chiplet of the multiple chiplets of the SoC for the one or more fault conditions; means for aggregating, by the second safety IC, a second set of the one or more fault conditions for the second chiplet; and means for communicating, by the second safety IC, information of the second set of the one or more fault conditions to the first safety IC.

Aspect 16: The apparatus of Aspect 14 or 15, in which one of the first safety IC or the second safety IC is designated as a primary safety IC, and the apparatus further comprises means for communicating, by the primary safety IC, information for one or more of the first set of the one or more fault conditions or the second set of the one or more fault conditions to a controller.

Aspect 17: The apparatus of any of Aspects 14-16, in which the primary safety IC communicates with the controller to initiate a corrective action for the one or more of the first set of the one or more fault conditions or the second set of the one or more fault conditions.

Aspect 18: The apparatus of any of Aspects 14-17, further comprising means for communicating information of the first set of the one or more fault conditions or the second set of the one or more fault conditions to another safety IC.

Aspect 19: The apparatus of any of Aspects 14-18, in which either of the first safety IC or the second safety IC are configured to monitor multiple chiplets.

Aspect 20: The apparatus of any of Aspects 14-19, in which the first safety IC and the second safety IC are arranged in a daisy chain configuration to enable failsafe operation using one of the first safety IC or the second safety IC.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

In one aspect, the monitoring means, aggregating means and/or communicating means may be the safety island 204a, 204b, or the die-to-die connection 208 as shown in FIG. 2, configured to perform the functions recited. In another configuration, the aforementioned means may be any module or any apparatus configured to perform the functions recited by the aforementioned means.

For a firmware and/or software implementation, the methodologies may be implemented with modules (e.g., procedures, functions, and so on) that perform the functions described. A machine-readable medium tangibly embodying instructions may be used in implementing the methodologies described. For example, software codes may be stored in a memory and executed by a processor unit. Memory may be implemented within the processor unit or external to the processor unit. As used, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include random access memory (RAM), read-only memory (ROM), electrically erasable read-only memory (EEPROM), compact disc read-only memory (CD-ROM) or other optical disk storage, magnetic disk storage or other magnetic storage devices, or other medium that can be used to store desired program code in the form of instructions or data structures and that can be accessed by a computer. Disk and disc, as used, include compact disc (CD), laser disc, optical disc, digital versatile disc (DVD), floppy disk, and Blu-ray® disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions, and alterations can be made without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present disclosure is not intended to be limited to the particular configurations of the process, machine, manufacture, composition of matter, means, methods, and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding configurations described may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the present disclosure may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in RAM, flash memory, ROM, erasable programmable read-only memory (EPROM), EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the present disclosure is provided to enable any person skilled in the art to make or use the present disclosure. Various modifications to the disclosure will be readily apparent to those skilled in the art, and the generic principles defined may be applied to other variations without departing from the spirit or scope of the disclosure. Thus, the present disclosure is not intended to be limited to the examples and designs described but is to be accorded the widest scope consistent with the principles and novel features disclosed.

What is claimed is:

1. An automotive system-on-a-chip (SoC), comprising:
a first chiplet coupled to a first safety integrated circuit (IC), the first safety IC monitoring the first chiplet for one or more fault conditions; and
a second chiplet coupled to a second safety IC, the second safety IC monitoring the first chiplet for the one or more fault conditions, in which the first safety IC aggregates a first set of the one or more fault conditions for the first chiplet and communicates information of the first set of the one or more fault conditions to the second safety IC.

2. The automotive SoC of claim 1, in which the second safety IC aggregates a second set of the one or more fault conditions for the second chiplet and communicates information of the second set of the one or more fault conditions to the first safety IC.

3. The automotive SoC of claim 2, in which one of the first safety IC or the second safety IC is designated as a primary safety IC, and the primary safety IC communicates information for one or more of the first set of the one or more fault conditions or the second set of the one or more fault conditions to a controller.

4. The automotive SoC of claim 3, in which the primary safety IC communicates with the controller to initiate a corrective action for the one or more of the first set of the one or more fault conditions or the second set of the one or more fault conditions.

5. The automotive SoC of claim 2, further comprising a communication interface coupled between the first safety IC and the second safety IC, in which either of the first safety IC or the second safety IC are configured to communicate information of the first set of the one or more fault conditions or the second set of the one or more fault conditions to another safety IC via the communication interface.

6. The automotive SoC of claim 1, in which either of the first safety IC or the second safety IC are configured to monitor multiple chiplets.

7. The automotive SoC of claim 1, in which the first safety IC and the second safety IC are arranged in a daisy chain configuration to enable failsafe operation using one of the first safety IC or the second safety IC.

8. A processor-implemented method performed by one or more processors, the processor-implemented method, comprising:
monitoring, by a first safety integrated circuit (IC) of a system-on-a-chip (SoC), a first chiplet of multiple chiplets of the SoC for one or more fault conditions;
aggregating, by the first safety IC, a first set of the one or more fault conditions for the first chiplet of the multiple chiplets of the SoC; and
communicating, by the first safety IC, information of the first set of the one or more fault conditions for the first chiplet of the multiple chiplets of the SoC to a second safety IC of the SoC.

9. The processor-implemented method of claim 8, further comprising:
monitoring, by the second safety IC of the SoC, a second chiplet of the multiple chiplets of the SoC for the one or more fault conditions;
aggregating, by the second safety IC, a second set of the one or more fault conditions for the second chiplet; and
communicating, by the second safety IC, information of the second set of the one or more fault conditions to the first safety IC.

10. The processor-implemented method of claim 9, in which one of the first safety IC or the second safety IC is designated as a primary safety IC, and the processor-implemented method further comprises communicating, by the primary safety IC, information for one or more of the first set of the one or more fault conditions or the second set of the one or more fault conditions to a controller.

11. The processor-implemented method of claim 10, in which the primary safety IC communicates with the controller to initiate a corrective action for the one or more of the first set of the one or more fault conditions or the second set of the one or more fault conditions.

12. The processor-implemented method of claim 9, in which the first safety IC or the second safety IC are configured to communicate information of the first set of the one or more fault conditions or the second set of the one or more fault conditions to another safety IC using a communication interface coupled between the first safety IC and the second safety IC.

13. The processor-implemented method of claim 8, in which either of the first safety IC or the second safety IC are configured to monitor multiple chiplets.

14. An apparatus, comprising:
means for monitoring, by a first safety integrated circuit (IC) of a system-on-a-chip (SoC), a first chiplet of multiple chiplets of the SoC for one or more fault conditions;
means for aggregating, by the first safety IC, a first set of the one or more fault conditions for the first chiplet of the multiple chiplets of the SoC; and
means for communicating, by the first safety IC, information of the first set of the one or more fault conditions for the first chiplet of the multiple chiplets of the SoC to a second safety IC of the SoC.

15. The apparatus of claim 14, further comprising:
means for monitoring, by the second safety IC of the SoC, a second chiplet of the multiple chiplets of the SoC for the one or more fault conditions;
means for aggregating, by the second safety IC, a second set of the one or more fault conditions for the second chiplet; and
means for communicating, by the second safety IC, information of the second set of the one or more fault conditions to the first safety IC.

16. The apparatus of claim 15, in which one of the first safety IC or the second safety IC is designated as a primary safety IC, and the apparatus further comprises means for communicating, by the primary safety IC, information for one or more of the first set of the one or more fault conditions or the second set of the one or more fault conditions to a controller.

17. The apparatus of claim 16, in which the primary safety IC communicates with the controller to initiate a corrective action for the one or more of the first set of the one or more fault conditions or the second set of the one or more fault conditions.

18. The apparatus of claim 15, further comprising means for communicating information of the first set of the one or more fault conditions or the second set of the one or more fault conditions to another safety IC.

19. The apparatus of claim 18, in which either of the first safety IC or the second safety IC are configured to monitor multiple chiplets.

20. The apparatus of claim 14, in which the first safety IC and the second safety IC are arranged in a daisy chain configuration to enable failsafe operation using one of the first safety IC or the second safety IC.
